(19) United States
(12) Patent Application Publication
(10) Pub. No.: US 2026/0002613 A1
(43) Pub. Date: Jan. 1, 2026

(54) Piping Connection Seal and Leak Detection

(71) Applicant: United States Department of Energy, Washington, DC (US)

(72) Inventor: Feng Cai, Milltown, NJ (US)

(21) Appl. No.: 18/758,144

(22) Filed: Jun. 28, 2024

(51) Int. Cl. F16L 17/10

(52) U.S. Cl. CPC F16L 17/10; F16L 23/167; F16L 2201/30

(57) ABSTRACT

One or more embodiments relate to a method and device able to maintain the integrity of pipelines, improving sealing and safety. One or more embodiments relate to the method and device that monitors leaked hazardous substances in the event of a leak. One or more embodiments relate to a pipeline connection seal device including a first pipe connector; a second pipe connector; and a vacuum-pumped interspace defined by at least the first pipe connector and the second pipe connector. The vacuum-pumped interspace reduces the pressure gradient across the pipeline connection seal device and monitors leaking hazardous substances and prevents them from escaping the seal device and going ambient.

### STATEMENT OF GOVERNMENT INTEREST

The United States Government has rights in this Invention pursuant to Contract No. DE-AC02-09-CH11466 between the U.S. Department of Energy and The Trustees of Princeton University for the operation of the Princeton Plasma Physics Laboratory.

### BACKGROUND OF THE INVENTION

It is recognized that pipelines are a low-cost option for transporting hazardous materials in comparison to other transportation methods. The U.S. Department of Transportation reports that there are about 3.3 million miles of regulated pipelines that carry 1.2 million daily shipments of hazardous materials. Furthermore, 64% of the U.S. energy commodities are transported by pipelines. However major barriers to expanding the pipeline delivery infrastructure include concerns over pipeline safety and containment.

A need exists in the art of a method or device that maintains the integrity of pipelines, improving sealing and safety. A further need exists for a method or device that monitors leaked hazardous substances in the event of a leak.

### SUMMARY OF THE INVENTION

It should be appreciated that the rates of leakage and permeation in a sealing device are proportional to the pressure gradient across a gasket therein. One or more embodiments relate to using double seal rings with a vacuum-pumped channel or interspace to reduce the pressure gradient across the seal device. The pressure in the vacuum-pumped channel or interspace guard channel may be maintained at 1 Torr or lower and reduce the pressure gradient across the seal by (in comparison to the ambient pressure of 760 Torr), thereby significantly improving the effect of the seal and the level of safety. Additionally, the vacuum-pumped guard channel or innerspace can quickly target leaking hazardous substances. One or more embodiments improves the effect of the seal and act as a chemical detection device as well. Embodiments of the seal device may be industrially standardized to replace the existing single-ring piping connection seals, thereby improving safety.

Embodiments relate to a pipeline connection seal device to improve the seal effect and safety level. It is composed of a pair of coaxial gaskets with a vacuum-pumped guard channel between them. The vacuum-pumped guard channel reduces the pressure gradient across the seal device and monitors the leaked hazardous substances in case of leaking.

One or more embodiments relate to a pipeline connection seal device to improve the seal effect and safety level. It is composed of a pair of coaxial gaskets with a vacuum-pumped guard channel between them. The vacuum-pumped guard channel reduces the pressure gradient across the seal device and monitors the leaked hazardous substances in case of leaking.

One or more embodiments relate to a method and device able to maintain the integrity of pipelines, improving sealing and safety. One or more embodiments relate to the method and device that monitors leaked hazardous substances in the event of a leak. One or more embodiments relate to a pipeline connection seal device including a first pipe connector; a second pipe connector; and a vacuum-pumped interspace defined by at least the first pipe connector and the second pipe connector. The vacuum-pumped interspace reduces the pressure gradient across the pipeline connection seal device and monitors leaking hazardous substances and prevents them from escaping the seal device and going ambient.

One object of at least one embodiment is related to a method and device that improves sealing and safety. More specifically, one object of at least one embodiment is a method and device that reduces the pressure gradient across a seal device and monitors the leaked hazardous substances in case of leaking.

Embodiments of the pipeline connection seal device may include at least one seal in communication with at least the vacuum-pumped interspace. More specifically it may include a first seal and a second seal, wherein at least one of the first seal and second seal are in communication with the vacuum-pumped interspace and at least one of the first pipe connector and the second pipe connector. Embodiments may include a port in fluid communication with the vacuum-pumped interspace.

Still another embodiment relates to a pipe (a single wall or double wall pipe) having a pipeline connection seal device. In this embodiment, the pipe includes a first pipeline; a second pipeline; and the pipeline connection seal device in contact with the first pipeline and the second pipeline. The pipeline connection device includes a first pipe connector; a second pipe connector; and a vacuum-pumped interspace defined by at least the first pipe connector and the second pipe connector. In at least this embodiment, the vacuum-pumped interspace reduces the pressure gradient across the pipeline connection seal device, monitors leaking hazardous substances, and prevents them from escaping the seal device and going ambient.

The pipeline connection seal device may include at least one seal in communication with at least the vacuum-pumped interspace. More specifically the pipeline connection seal device may include a first seal and a second seal, wherein at least one of the first seal and second seal are in communication with the vacuum pumped interspace and at least one of the one of the first pipe connector and the second pipe connector. Embodiments may include a port in fluid communication with the vacuum-pumped interspace.

Yet another embodiment relates to a method of sealing a pipe having a first pipeline and second pipeline. In this embodiment, the method includes connecting the first pipeline and the second pipeline forming a pipeline connection; and defining a vacuum-pumped interspace. Embodiments may include reducing a pressure gradient across the pipeline connection and/or monitoring leaking hazardous substances and prevents them from going ambient.

### BRIEF DESCRIPTION OF DRAWINGS

The invention together with the above and other objects and advantages will be best understood from the following detailed description of the preferred embodiment of the invention shown in the accompanying drawings, wherein:

FIG. 1 depicts a schematic representation of a cross-section of a first or single wall pipeline connection seal and leak detection device in accordance with one embodiment;

FIG. 2 depicts a schematic representation of a cross-section of a second or double wall pipeline connection seal and leak detection device in accordance with one embodiment, and

FIG. 3 depicts a flowchart illustrating a method of sealing a pipe having a first pipeline and second pipeline.

### DETAILED DESCRIPTION OF THE INVENTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

Embodiments relate to a pipeline connection seal device to improve the seal effect and safety level. It is composed of a pair of coaxial gaskets with a vacuum-pumped guard channel between them. The vacuum-pumped guard channel reduces the pressure gradient across the seal device and monitors the leaked chemicals in case of leaking.

Known sealing devices such as the Double O-Ring Sealing Arrangement described in U.S. Pat. No. 4,795,173, include a double O-ring arrangement and a storage-buffer chamber kept at a pressure. The high pressure in the storage-buffer chamber assists the sealing arrangement form preventing pressure outside the sealing arrangement from entering the storage-buffer chamber.

It should be appreciated that such known arrangement is limited in use to hydraulic fluid applications. It does not include a vacuum-pumped interspace, thereby improving sealing effects for a low-pressure pipeline nor does it detect leaking.

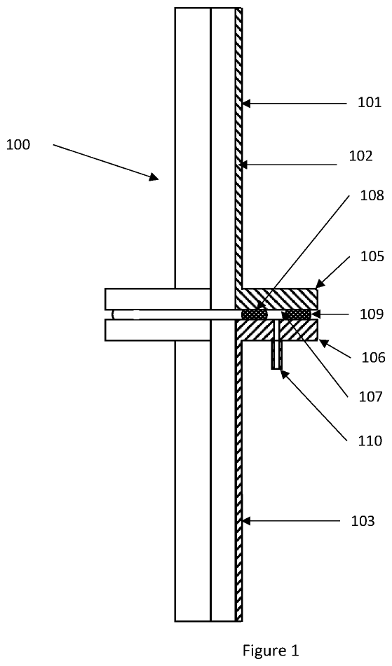

Referring now to the drawings wherein like reference numerals are used to designate like parts, and more particularly to one or more embodiments related to a pipeline connection seal and leak detection device 100 shown in FIG. 1 (a single wall configuration for example). In one or more embodiments, the device 100 includes a pair of coaxial gaskets with a vacuum-pumped guard channel between them. The vacuum-pumped guard channel reduces the pressure gradient across the device and monitors the leaked hazardous materials in case of leaking.

More specifically, FIG. 1 depicts device 100 in contact with or contained in pipe 101 having a first pipeline 102 and a second pipeline 103. The device 100 includes a first pipe connector 105 and a second pipe connector 106 such that at least a portion of the first pipe connector 105 is in contact with at least a portion of the first pipeline 102 and at least a portion of the second pipe connector 106 is in contact with at least a portion of the second pipeline 103, defining a vacuum-pumped interspace 107.

FIG. 1 further illustrates that in one embodiment, device 100 further includes first or inner seal 108 and a second or outer seal 109 positioned in vacuum-pumped interspace 107 such that at least one or both of the first or inner seal 108 and second or outer seal 109 contact first and second pipe connectors 105 and 106. In at least one embodiment, first or inner seal 108 and second or outer seal 109 are arranged coaxially and form the vacuum-pumped interspace 107 along with the first and second pipe connectors 105 and 106. Further, as shown, interspace 107 includes a port 110 in fluid communication therewith, enabling a vacuum to be produced and allowing sampling.

It should be appreciated that one or more of the embodiments relate to a pipeline connection seal device 100 with a vacuum-pumped interspace 107. The interspace 107 may be pumped to the range of 1 Torr or lower using port 110 to reduce the pressure gradient across the overall seal, significantly improving the effect of the seal. Additionally, the vacuum-pumped interspace 107 can quickly target hazardous substances in case of leaking.

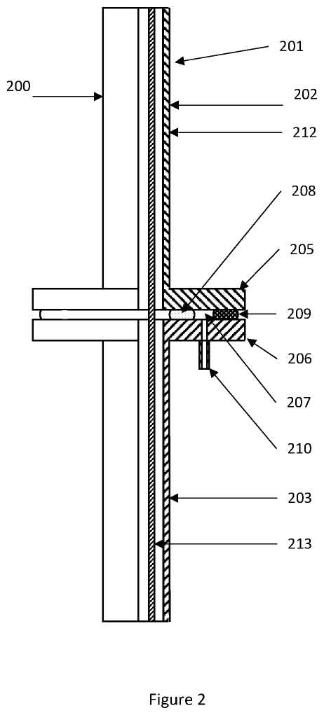

Additional embodiments are contemplated including a pipeline connection seal and leak detection device 200 as shown in FIG. 2 (a coaxial double-wall configuration for example). In one or more embodiments, the device 200 includes a pair of coaxial gaskets with a vacuum-pumped guard channel between them. The vacuum-pumped guard channel reduces the pressure gradient across the device and monitors the leaked hazardous materials in case of leaking.

More specifically, FIG. 2 depicts device 200 in contact with or contained in pipe 201 having a first pipeline 202 and a second pipeline 203. The device 200 includes a first pipe connector 205 and a second pipe connector 206 such that at least a portion of the first pipe connector 205 is in contact with at least a portion of the first pipeline 202 and at least a portion of the second pipe connector 206 is in contact with at least a portion of the second pipeline 203, defining a vacuum-pumped interspace 207.

FIG. 2 further illustrates that in one embodiment device 200 further includes an optional first or inner seal 208 and a second or outer seal 209 positioned in vacuum-pumped interspace 207 such that at least one or both first or inner seal 208 and second or outer seal 209 contact first and second pipe connectors 205 and 206. In at least one embodiment, optional first or inner seal 208 and second or outer seal 209 form a vacuum-pumped interspace 207 along with the first and second pipe connectors 205 and 206. In at least one embodiment, the first or inner seal 208 and second or outer seal 209 are arranged coaxially. Further, as shown, interspace 207 includes a port 210 in fluid communication therewith, enabling a vacuum to be produced and allowing sampling. FIG. 2 further depicts pipeline outer wall 212 and pipeline inner wall 213.

It should be appreciated that one or more of the embodiments relate to a pipeline connection seal device 200 with a vacuum-pumped interspace 207. The interspace 207 may be pumped to the range of 1 Torr or lower using port 210 to reduce the pressure gradient across the overall seal, significantly improving the effect of the seal. Additionally, the vacuum-pumped interspace 207 can quickly target hazardous substances in case of leaking.

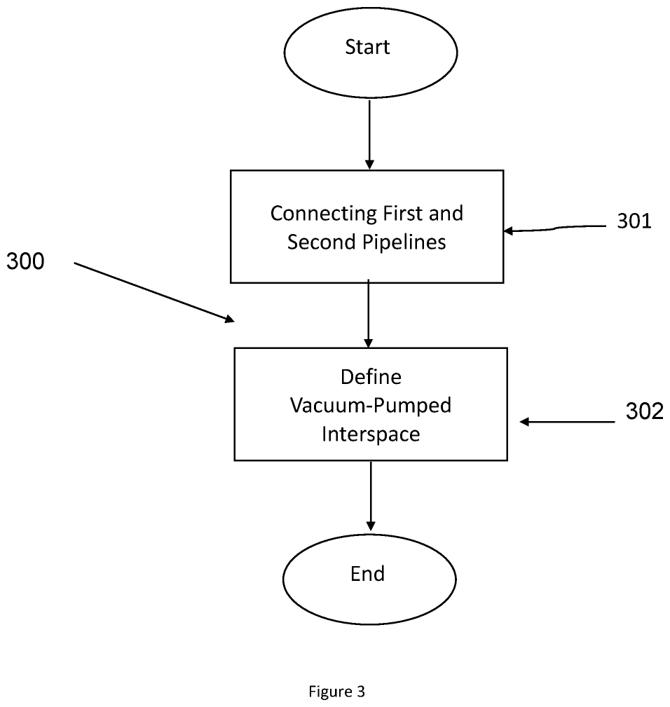

Referring now to FIG. 3 which depicts one embodiment related to a method of sealing a pipe having a first pipeline and second pipeline, and generally designated 300. As shown, method 300 includes connecting the first pipeline and the second pipeline forming a pipeline connection, block 301. FIG. 3 further depicts method 300 including defining a vacuum-pumped interspace, block 302. In one or more embodiments, method 300 includes reducing a pressure gradient across the pipeline connection and/or monitoring leaking hazardous substances, preventing the leaking substances from escaping the seal and going ambient.

It should be appreciated that one or more of the embodiments of method 300 relate to a pipeline connection seal device with a built-in vacuum-pumped interspace. The interspace may be pumped to the range of 1 Torr or lower to reduce the pressure gradient across the overall seal, significantly improving the effect of the seal. Additionally, the vacuum-pumped interspace can quickly target hazardous substances in case of leaking.

Embodiments of the device may replace the weldment of inner and outer tubes in a coaxial (double-wall) pipeline, avoiding the potential leakage at the weld spots of inner and outer tubes, increase the effect of seal, target leaked gases in case of leaking, and make repairing and maintenance easier.

The rates of leakage and permeation in known seal devices are proportional to the pressure gradient across the gasket. Embodiments uses double seal rings with a vacuum-pumped interspace to reduce the pressure gradient across the seal device. The interspace can be pumped to the range of 1 Torr or lower and reduces the pressure gradient across the seal by at least (comparing to the ambient pressure 760 Torr), significantly improves the effect of seal and the level of safety. Also, this vacuum pumped guard channel can quickly target the leaks of chemicals in the case of leaking. Thus, this invention improves the effect of seal and acts as a chemical detection device as well. This type of seal device can be industrially standardized to replace the existing single-ring piping connection seals and improve the level of safety.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

1. (canceled)

2. (canceled)

3. (canceled)

4. (canceled)

5. A pipe having a pipeline connection seal device, the pipe comprising:
a first pipeline having a first pipeline outer wall defining a first pipeline interior containing a first pipeline inner wall;
a second pipeline having a second pipeline outer wall defining a second pipeline interior containing a second pipeline inner wall; and
the pipeline connection seal device in contact with the first pipeline and the second pipeline, the pipeline connection seal device comprising:
a first pipe connector;
a second pipe connector; and
a vacuum-pumped interspace defined by at least the first pipe connector and the second pipe connector, whereby the vacuum-pumped interspace reduces the pressure gradient across the pipeline connection seal device and monitors leaking hazardous substances and prevents them from escaping the seal device and going ambient.

6. The pipe of claim 5, the pipeline connection seal device further comprising at least one seal in communication with at least the vacuum-pumped interspace.

7. The pipe of claim 5, the pipeline connection seal device further comprising a first seal and a second seal, wherein at least one of the first seal and second seal is in communication with the vacuum pumped interspace and at least one of the first pipe connector and the second pipe connector.

8. The pipe of claim 5, the pipeline connection seal device further comprising a port in fluid communication with the vacuum-pumped interspace.

9. (canceled)

10. (canceled)

11. A pipe having a pipeline connection seal device, the pipe comprising:
a first pipeline having a first pipeline outer wall defining a first pipeline interior containing a first pipeline inner wall;
a second pipeline having a second pipeline outer wall defining a second pipeline interior containing a second pipeline inner wall; and
the pipeline connection seal device in contact with the first pipeline and the second pipeline, the pipeline connection seal device comprising:
a first pipe connector;
a second pipe connector; and
a vacuum-pumped interspace defined by at least the first pipe connector and the second pipe connector, whereby the vacuum-pumped interspace reduces the pressure gradient across the pipeline connection seal device and monitors leaking hazardous substances and prevents them from escaping the sealing device and going ambient.

12. (canceled)

13. (canceled)

14. (canceled)

15. (canceled)

16. The pipe of claim 5 wherein the first pipeline interior is in fluid communication with the second pipeline interior.

17. The pipe of claim 5 wherein the first pipeline inner wall is coupled to the second pipeline inner wall.
